(19) United States
(12) Patent Application Publication
(10) Pub. No.: US 2026/0264241 A1
(43) Pub. Date: Sep. 10, 2026

(54) Checking a Predefined Path of a Robot

(71) Applicants: KUKA Deutschland GmbH, Augsburg (DE); KUKA Systems GmbH, Augsburg (DE)

(72) Inventors: Juergen Blume, Friedberg (DE); Ingo Kresse, Augsburg (DE); Pascal Caprano, Augsburg (DE); Marcus Hofmann, Seesen (DE); Fabian Jennrich, Muenchen (DE)

(73) Assignees: KUKA Deutschland GmbH, Augsburg (DE); KUKA Systems GmbH, Augsburg (DE)

(21) Appl. No.: 18/847,023

(22) PCT Filed: Mar. 13, 2023
(86) PCT No.: PCT/EP2023/056355

§ 371 Date: Sep. 13, 2024

(30) Foreign Application Priority Data
Mar. 15, 2022 (DE) 10 2022 202 562.8
Mar. 15, 2022 (DE) 10 2022 202 563.6
Mar. 15, 2022 (DE) 10 2022 202 564.4
Mar. 15, 2022 (DE) 10 2022 202 569.5
Mar. 15, 2022 (DE) 10 2022 202 571.7

(51) Int. Cl. B25J 9/16; B25J 13/06; G06T 19/00

(52) U.S. Cl. CPC B25J 9/1671; B25J 13/06; G06T 19/006

(57) ABSTRACT

A method for checking a predefined path of a robot includes determining or providing a computer-implemented three-dimensional environment model; determining a distance between a computer-implemented model of the robot and the environment model for different portions of the path; and visualizing a virtual representation of the path using a visualization device in an augmented reality for checking the path, wherein, in this visualization, a warning is issued for a portion of the path if the distance determined for this portion falls within a predefined warning range, and an all-clear is issued for a portion of the path if the distance determined for this portion falls within an all-clear range.

### CROSS-REFERENCE TO RELATED APPLICATIONS

This application is a national phase application under 35 U.S.C. § 371 of International Patent Application No. PCT/EP2023/056355, filed Mar. 13, 2023 (pending), which claims the benefit of priority to German Patent Application Nos. DE 10 2022 202 562.8, DE 10 2022 202 563.6, DE 10 2022 202 564.4, DE 10 2022 202 569.5, and DE 10 2022 202 571.7, each filed Mar. 15, 2022; and is related to U.S. patent application Ser. No. ______ (Attorney Docket No. KUKAR-188), U.S. patent application Ser. No. ______ (Attorney Docket No. KUKAR-189), U.S. patent application Ser. No. ______ (Attorney Docket No. KUKAR-190), and U.S. patent application Ser. No. ______ (Attorney Docket No. KUKAR- 193), each filed Sep. 13, 2024, the disclosures of which are incorporated by reference herein in their entirety.

### TECHNICAL FIELD

The present invention relates to a method and system for checking a predefined path of a robot, and to a computer program or computer program product for carrying out the method.

### BACKGROUND

Robot paths can be predefined in particular using a simulated environment and/or by teaching, in particular of path points.

For commissioning in particular, it is preferable to check in advance whether a real robot could or would collide with its real environment, which may differ from the simulated environment or the real environment as it was during teaching, when traveling on a predefined path.

### SUMMARY

The object of the present invention is to improve the operation of robots, in particular (by) checking predefined paths.

This object is achieved by a method, a system, or computer program or computer program product for carrying out a method as described herein.

According to one embodiment of the present disclosure, a method for checking a predefined path of a robot (“robot path”) comprises the steps of:
determining or providing a computer-implemented three-dimensional environment model;
determining a distance between
a computer-implemented model of the robot and
the environment model
for different portions of the path; and
visualizing a virtual representation of the path using a visualization device in an augmented reality for checking the path, wherein in this visualization
a warning is issued for a portion of the path if the distance determined for this portion is within a predefined warning range, and
an all-clear is issued (instead) to a portion of the path, in particular this portion, if the distance determined for this portion is within a predefined all-clear range.

In one embodiment, this allows a checking person to reliably and/or quickly check the predefined path for the risk of possible collisions with the real environment. In one embodiment, the path is checked, preferably by the or a checking person, using or on the basis of the visualized virtual representation and the warning and/or all-clear issued; in a further embodiment, one or more portions of the path for which a warning is issued (in each case) are checked in a (more) specific, in particular in-depth, precise and/or separate manner, in particular for possible collisions of the robot with the environment, and the path, in particular at least this/these portion(s), is/are modified if necessary.

In one embodiment, the robot comprises a robot arm with three or more, preferably at least six, in one embodiment at least seven, joints; in a further embodiment, swivel joints, which connect movable links of the robot to one another and are movable by drives, in particular motors, of the robot, and/or a mobile base, in particular one which can be moved using at least one drive, in particular motor, of the robot. The invention is particularly advantageous for such robots, in particular due to the complex paths it allows for. In one embodiment, a robot-guided tool or workpiece forms a (distal) movable link of the robot within the meaning of the present invention, or the model of the robot (also) comprises a model of a robot-guided tool or workpiece.

In one embodiment, the path is predefined by the program or by a work program and is, in particular, predetermined in a further embodiment using a simulated environment and/or by teaching, in particular of path points.

In one embodiment, the three-dimensional environment model comprises data, in particular permanently or temporarily stored data, which indicate or describe one or more three-dimensional contour(s) or geometry (or geometries) of a real environment of the robot, in particular a robot cell, production or storage hall or similar.

In one embodiment, the model of the robot comprises data, in particular permanently or temporarily stored data, which indicate or describe the three-dimensional contour(s) or geometry (or geometries) of the (real) robot, in particular of one or more of its movable links. As mentioned above, in one embodiment, a robot-guided tool or workpiece forms a (distal) movable link of the robot within the meaning of the present invention, or the model of the robot (also) comprises a model of a robot-guided tool or workpiece.

A portion of the path for which a warning or all-clear is issued can consist of a (path) point or be a (path) point for which the distance is determined.

In one embodiment, a portion of the path for which a warning or all-clear is issued extends beyond a (path) point on one or both sides or comprises several (path) points; it can be continuous or discrete, in particular a continuous or discrete sequence of points.

In one embodiment, to determine the distance for a portion comprising multiple points, the distance of a selected one of these points, for example a start, end or middle point of this portion (as the distance of this portion) is determined and, in a further embodiment, the portion comprising a plurality of points is colored according to or as a function of the determined distance of this point. This means that the check can be carried out (more) quickly in one embodiment.

In one embodiment, to determine the distance for a portion comprising multiple points, the distances of two or more discrete, in particular selected, points of this portion, for example a start point and an end point of this portion, a start point, an end point and a middle point of this portion or the like, are determined and the smallest of these distances is determined as the distance of this portion. This means that the check can be carried out both quickly and precisely in one embodiment.

In one embodiment, to determine the distance for a portion comprising several points, in particular a continuous portion, the minimum distance or the distance to the point nearest to the environment model is determined as the distance of this portion. This means that the check can be carried out (more) precisely in one embodiment.

In a further embodiment, a portion, in particular a portion consisting of one or more points, is colored according to or as a function of the determined distance. This can improve the precision of the check in one embodiment. For example, a point or portion, in particular a portion comprising a single point or multiple points, is colored red to issue a warning and/or green to issue an all-clear. Similarly, the coloring can also be multi-level and/or otherwise discretized, for example in {red, yellow, green} or similar, in particular with other colors and/or more finely discretized, or change continuously with the relevant, in particular smallest, distance, for example from red for (too) small distances to green for (sufficiently) large distances or similar.

In one embodiment, the method comprises the step of:
detecting data of a real environment of the robot using a detection device which is mobile in one embodiment and portable in a further embodiment, in particular by a person;
wherein the environment model is determined on the basis of this detected data.

In one embodiment, this allows a real environment of the robot to be advantageously taken into account during the check and thus the risk of a collision with it can be checked particularly reliably.

In one embodiment, the detection device is arranged, in a further embodiment integrated or detachably arranged, on the visualization device. In one embodiment, this allows the environment model to be advantageously determined in situ or promptly before visualization, making it particularly up-to-date and thus the check particularly reliable and meaningful.

In one embodiment, the detection device is moved in a translational and/or rotational and/or manual manner, in particular by a checking person handling the visualization device, relative to the real environment to detect the data. In one embodiment, this allows a larger region of the environment and/or the environment to be detected (more) precisely, making the check particularly reliable or meaningful.

In one embodiment, the detection device comprises one or more non-contact measuring distance meters, in a further embodiment one or more radar distance meters, one or more ultrasonic distance meters and/or one or more lidar distance meters. This allows the environment model to be determined precisely in one embodiment, making the check particularly reliable and meaningful. Lidar distance meters are particularly advantageous here, as they are compact and measure precisely.

Additionally or alternatively, the detection device comprises one or more cameras, in one embodiment a 3D camera system, which in one embodiment comprises at least two or stereo cameras, a triangulation system, in which at least one light source images a defined pattern onto the environment and at least one camera captures this pattern, preferably from a different angle of view, at least one TOF camera, at least one interferometry camera, at least one light field camera or similar, and/or image evaluation. This allows the environment to be detected (more) quickly in one embodiment and thus the check can be carried out particularly quickly and/or a larger environment can be taken into account.

Alternatively, or particularly preferably in addition to the determination on the basis of the detected data of the real environment, the environment model is determined in one embodiment on the basis of predefined nominal data, in a further embodiment CAD data, of the environment. In one embodiment, by taking such data into account, the environment model can be determined (more) quickly and/or (more) precisely.

In one embodiment, the model of the robot is determined on the basis of predefined nominal data, in a further embodiment on the basis of the predefined path of the robot and/or on the basis of CAD data of the robot, and/or a measurement of the robot. In one embodiment, by taking such data into account, the model of the robot can be determined (more) quickly and/or (more) precisely. In one embodiment, the model of the robot comprises a predefined pose of the robot links relative to one another and/or a reference system fixed to the environment for the different portions, in particular points, of the predefined path, or indicates such a pose. In one embodiment, a pose or position and orientation within the meaning of the present invention comprises a one-, two- or three-dimensional position and/or a one-, two- or three-dimensional orientation.

As explained above, in one embodiment, a robot-guided tool or workpiece forms a movable link of the robot within the meaning of the present invention. Accordingly, in one embodiment, the model of the robot comprises a computer-implemented model of a robot-guided tool or workpiece as a movable link of the robot. In one embodiment, this can advantageously check the risk of a collision of a robot-guided tool or workpiece with the environment. Accordingly, in one embodiment, the model of the robot is determined on the basis of predefined nominal data, in a further embodiment CAD data, of the tool or workpiece, and/or a measurement of the tool or workpiece.

In one embodiment, the environment model comprises one or more geometry primitives in a predefined relation, in particular spatial position and orientation, to a real environment obstacle, in particular thus to several real environment obstacles, in each case at least one geometry primitive in a predefined relation, in particular spatial position and orientation, to this real environment obstacle. Additionally or alternatively, in one embodiment, the model of the robot comprises one or more geometry primitives in a predefined relation, in particular spatial position and orientation, to a link of the robot, in particular thus to several links of the robot, preferably at least one end effector, in each case at least one geometry primitive in a predefined relation, in particular spatial position and orientation, to this robot link. This means that the distances can be determined (more) quickly in one embodiment. In one embodiment, a geometry primitive within the meaning of the present invention is a polyhedron, in particular a prism, in particular a cuboid, or a cylinder, cone, ellipsoid, in particular a sphere, or similar. This means that the distances can be determined particularly quickly in one embodiment.

In one embodiment, the environment model is determined using at least one approximation of features, in particular points, detected with the aid of the detection device, particularly preferably a point cloud detected using the detection device, in a further embodiment using one or more grids and/or one or more approximation surfaces, in particular planar approximation surfaces and/or single or multiple curved approximation surfaces, wherein such grids or approximation surfaces are determined in one embodiment by equalization, in particular interpolation or extrapolation, smoothing and/or other fitting functions of points detected by means of the detection device, in particular the environment model may comprise this approximation. Such an approximation can be used to model the environment in one embodiment in a particularly advantageous manner, in particular quickly and/or precisely.

In one embodiment, the environment model is determined on the basis of the robot, in particular using data detected by the robot, in particular by the detection device, and/or on the basis of the model of the robot. In a further embodiment, the robot, which may also be detected during the detection of data from the robot's real environment using the detection device, is at least partially eliminated or masked out. This allows the environment model to be improved in one embodiment.

In one embodiment, the environment model is determined based on a selection of an environment region by a checking person. In a further embodiment, an environment region selected by the checking person is not taken into account by the environment model; in a further embodiment it is not detected using the detection device, and/or only an environment region selected by the checking person is taken into account by the environment model, in a further embodiment only this environment region is detected by the detection device. This allows the environment model to be improved and/or determined (more) quickly in one embodiment.

In one embodiment, the distance between the model of the robot, and the environment model for one or more of the different portions of the path is determined in each case based on a minimum distance between
an imaginary envelope of a selected movable link of the robot, in one embodiment of a robot-guided tool or workpiece
or
an imaginary envelope of multiple, in one embodiment all, movable links of the robot, in one embodiment correspondingly including a robot-guided tool or workpiece
and
an imaginary envelope of the entire environment of the robot described by the environment model or
an imaginary envelope of a selected part of this environment or envelope,
and may in particular be the corresponding distance.

Such an imaginary envelope is in one embodiment at least partially represented by the model of the robot or environment model; in one embodiment, one or more of the geometry primitives of the robot model and/or one or more of the geometry primitives of the environment model and/or the approximation of points detected using the detection device, by which the environment model is determined or which the environment model comprises, can in particular be formed at least partially by surfaces, corners, edges, nodes, coordinate lines or similar of the geometry primitives or the approximation, in particular of the grid(s) or the approximation surface(s), and/or comprise a predefined, in particular minimum and/or maximum, distance from the robot (link) or a surface of the environment or the environment region and/or a predefined, in particular minimum and/or maximum, distance from the geometry primitive(s), grid(s) or approximation surface(s) or be defined or predefined accordingly. In particular, an imaginary envelope can be continuous or discrete. Thus, for example, the minimum distance between corners, edges and/or surfaces of a geometry primitive of the robot model in the form of a cuboid and a grid or an approximation surface of the environment model can be used to determine a distance between the model of the robot and the environment model.

By determining the distance on the basis of a minimum distance of an imaginary envelope of a selected moving link of the robot or of a selected partial region of the entire environment of the robot described by the environment model, in one embodiment the determination can be carried out (more) quickly, in particular limited to prima facie relevant regions.

By determining the distance based on a minimum distance of an imaginary envelope of several, in one embodiment all, movable links of the robot or the entire environment of the robot described by the environment model, the check can be carried out reliably in one embodiment, and in particular several different collision possibilities can also be taken into account.

In one embodiment, the visualization device is a mobile visualization device which is in particular portable (by a person, preferably with one hand); in one embodiment, it comprises a handheld apparatus, preferably a handheld, tablet, smartphone, a laptop or similar, and/or a pair of glasses, in particular a(ugmented) r(eality) glasses. This means that, in one embodiment, checking can be carried out in situ or on site and thus improved. In one embodiment, the visualization device is set up (in terms of hardware and/or software) to control the robot or is (also) used for this purpose. This means that commissioning can be carried out quickly and/or safely in one embodiment.

In one embodiment, the (visualized) virtual representation of the path comprises an, in one embodiment continuous, path of a robot-fixed reference point, preferably an end effector of the robot, and/or a representation of one or more, in particular all, movable links of the robot, in one embodiment by means of or using geometry primitives of the model of the robot. In one embodiment, the representation of the link or links of the robot changes during the visualization according to the predefined path; accordingly, the virtual representation may comprise in particular a virtual simulation of the robot or representation of the movement of one or more of its links when traveling on the path.

By visualizing the path, in one embodiment the check can be carried out (more) quickly and/or (more) reliably, in particular a checking person can check or assess the path in a (more) simple, intuitive and/or quick manner. In one embodiment, issuing a warning or all-clear comprises highlighting, preferably coloring and/or illuminating, the corresponding portion of the path or path of the according to the distance determined for this purpose, wherein different highlighting, preferably colors or lighting, can be assigned to different distances, for example, the color red is assigned to all distances in the warning range and the color green is assigned to all distances in the all-clear range, or the color red is assigned to all distances in the warning range, the color yellow is assigned to smaller distances in the all-clear range and the color green is assigned to larger distances in the all-clear range, or a color that changes continuously or in several discrete steps with the determined distance, and/or path or path portions with distances in the warning range are shown illuminated and path or path portions with distances in the all-clear range are shown non-illuminated, or the illumination changes with the distances.

Additionally or alternatively, issuing a warning or all-clear may comprise highlighting, preferably coloring and/or illuminating, the representation of one or more, in particular all, moving links of the robot according to the distance determined for the relevant portion, wherein different distances may be assigned different highlights, preferably colors and/or illuminations, such as described above. For example, the representation for or along portions with (too) small distances is colored red and for or along portions with (sufficiently) large distances is colored green, similarly the color of the representation can change continuously or in several discrete steps with the determined distance, and/or the representation for distances in the warning range is depicted illuminated and in the all-clear range is depicted non-illuminated, or their illumination changes with the distances.

Similarly, in one embodiment, the highlighting or issuance of a warning or all-clear can comprise a style of the corresponding path or path portion or the representation corresponding to the distance determined for this purpose, wherein different styles can be assigned to different distances, for example thick and/or solid lines to all distances in the warning range and thin and/or dashed lines to all distances in the all-clear range, although of course a variety of other styles can also be used, for example a line width can change continuously with the distance or in discrete steps or the like.

By highlighting, in particular coloring and/or illuminating, the path, in one embodiment a checking person can check or assess the path (more) quickly, by highlighting, in particular coloring and/or illuminating, the representation of the robot link(s) in a (more) intuitive and simplified manner and/or their visualization can be simplified and/or their recognizability can be improved through the variation of the style.

In one embodiment, a first virtual representation is used for visualizing a portion of the path when the distance determined for that portion is in the warning range, and a second virtual representation different therefrom is used to visualize that portion of the path when the distance determined for that portion is in the all-clear range. For example, as explained elsewhere, a first virtual representation comprising a red colored path portion of a robot-fixed reference point may be used for visualizing a portion of the path if the distance determined for that portion is within the warning range, and for visualizing that portion of the path, a second virtual representation different therefrom is used, comprising a green colored path portion of the robot-fixed reference point, if the distance determined for this portion is in the all-clear range.

In a further embodiment, a first virtual representation is used for visualizing a portion of the path if the distance determined for that portion is in one part of the warning range, and another first virtual representation is used for visualizing that portion of the path if the distance determined for that portion falls within another part of the warning range. Additionally or alternatively, in a further embodiment, a second virtual representation is used for visualizing a portion of the path if the distance determined for that portion is in one part of the all-clear range, and another second virtual representation is used for visualizing that portion of the path if the distance determined for that portion falls within another part of the all-clear range.

For example, a first virtual representation comprising a thick and/or red colored path portion of a robot-fixed reference point can be used for visualizing a portion of the path if the distance determined for this portion is within the warning range, another first virtual representation comprising a thinner and/or orange colored path portion of the reference point can be used if the distance determined for this portion is greater but still within the warning range, a second virtual representation comprising a thick and/or yellow colored path portion of the reference point can be used if the distance determined for this portion falls within the all-clear range, and another second virtual representation comprising a thinner and/or green colored path portion of the reference point can be used if the distance determined for this portion falls within the warning range but is greater.

The colors, lighting or styles, and divisions mentioned above are of course only examples, wherein a plurality of other discretizations and/or warnings or all-clear notifications are possible.

In one embodiment, when visualizing the virtual representation of the path, one or more parameters of the path are issued; in one embodiment, a velocity and/or at least one parameter, for example a velocity, for at least one portion, in particular point, of the path selected, in particular by a checking person, and/or at least one parameter, for example a velocity, for a portion, in particular point, of the path that is currently or presently traveled on or approached in a simulated manner during visualization.

Additionally or alternatively, when visualizing in one embodiment, a value of the determined distance for at least one portion of the path, in particular a global minimum distance and/or a distance for a portion, in particular point, of the path selected, in particular by a checking person, and/or for a portion, in particular a point approached in a simulated manner, of the path that is currently or presently traveled on in a simulated manner during visualization is issued.

The output of a parameter and/or a distance value is carried out numerically, acoustically and/or symbolically. For example, a direction of travel can be issued by an arrow, a TCP velocity by a corresponding number, a distance value symbolically by a corresponding line, in particular a dimension line with ends symbolized, for example, by arrows, horizontal lines or similar, and/or numerically by a corresponding number and/or a parameter or distance value acoustically, in particular by different pitches in relation to a reference tone, in particular a reference tone that corresponds to a zero value of the parameter or distance value.

In one embodiment, one or more of the above features allows a checking person to check or assess the path (more) quickly and/or (more) reliably.

Depending on the result of the check, the path is modified in one embodiment, in a further embodiment by (input or specifications of) the checking person or automatically. Then a method described here can be carried out again for or with the modified path(s) in order to check this modified path in an analogous manner, wherein in one further embodiment data of the real environment is detected again and the environment model is determined again on the basis of this data, which can advantageously take into account changes in the real environment; in another further embodiment, the previously used environment model is used instead or is provided (again), which can advantageously reduce effort and time requirements.

A system or method according to the present disclosure can be carried out with particular advantage during or for commissioning the robot for traveling on the predefined path, since safety can be increased and/or effort and/or time can be reduced with particular advantage in this case, but it is not limited to this.

According to one embodiment of the present disclosure, a system, in particular in terms of hardware and/or software, in particular in terms of programming, is configured to carry out a method described herein and/or comprises:
means for determining or providing a computer-implemented three-dimensional environment model;
means for determining a distance between a computer-implemented model of the robot and the environment model for different portions of the path; and
a visualization device for visualizing a virtual representation of the path in an augmented reality for checking the path, wherein, in this visualization a warning is issued for a portion of the path if the distance determined for this portion falls within a predefined warning range, and an all-clear is issued for a portion of the path if the distance determined for this portion falls within a predetermined all-clear range.

In one embodiment, the system or its means comprises:
an, in particular mobile, in particular portable, detection device for detecting data of a real environment of the robot and means for determining the environment model on the basis of this detected data, in particular using at least one approximation of points detected by means of the detection device, wherein the detection device is arranged on the visualization device in one embodiment and/or has at least one non-contact distance meter, in particular at least one lidar, radar or ultrasonic distance meter, and/or at least one camera, in particular a 3D camera system, and/or image evaluation; and/or
means for determining the environment model on the basis of predefined nominal data, in particular CAD data, of the environment and/or on the basis of the robot, in particular data of the robot detected using a detection device, in particular the detection device, and/or on the basis of the model of the robot and/or on the basis of a selection of an environment area by a checking person; and/or
means for determining the model of the robot on the basis of predefined nominal data, in particular the predefined path of the robot and/or CAD data of the robot, and/or a measurement of the robot; and/or
means for determining the distance between the model of the robot and the environment model for at least one of the different portions of the path on the basis of a minimum distance between an imaginary envelope of a selected movable link of the robot or an imaginary envelope of multiple, in particular all, movable links of the robot and an imaginary envelope of the entire environment of the robot described by the environment model or of a selected partial area thereof; and/or
means for using a first virtual representation for visualizing a portion of the path if the distance determined for this portion falls within the warning range, in particular a part of the warning range, and a second virtual representation different therefrom if the distance determined for this portion falls within the all-clear range, in particular a part of the all-clear range, in particular a different first virtual representation if the distance determined for this portion falls within a different part of the warning range, and/or a different second virtual representation if the distance determined for this portion falls within a different part of the all-clear range; and/or
means for outputting at least one parameter of the path, in particular a velocity and/or for at least one selected portion of the path and/or for a portion, in particular a point, of the path which is traveled on or approached in a simulated manner during visualization, and/or a value of the determined distance for at least one portion of the path, in particular a global minimum distance and/or a distance for a selected portion of the path and/or for a portion, in particular point, of the path traveled on or approached in a simulated manner during visualization, in particular numerically and/or symbolically during visualization of the virtual representation of the path; and/or
means for modifying the path.

A system and/or a means in the sense of the present disclosure may be designed in hardware and/or in software, and in particular may comprise at least one, in particular digital, processing unit, in particular microprocessor unit (CPU), graphic card (GPU) or the like, which is preferably data-connected or signal-connected to a memory system and/or bus system, and/or one or multiple programs or program modules. The processing unit may be designed to process commands that are implemented as a program stored in a memory system, to detect input signals from a data bus and/or to issue output signals to a data bus. A memory system may comprise one or more, in particular different, storage media, in particular optical, magnetic, solid-state, and/or other non-volatile media. The program may be such that it embodies or is capable of executing the methods described herein, so that the processing unit can execute the steps of such methods and thus, in particular, visualize the virtual representation of the path or issue the warning or all-clear. In one embodiment, a computer program product may comprise, in particular be, an, in particular computer-readable and/or non-volatile, storage medium for storing a program or instructions or with a program stored thereon or with instructions stored thereon. In one embodiment, execution of said program or said instructions by a system or controller, in particular a computer or an arrangement of multiple computers, causes the system or controller, in particular the computer(s), to carry out a method described herein or one or more steps thereof, or the program or instructions are configured to do so.

In one embodiment, one or more, in particular all, steps of the method are implemented completely or partially automatically, in particular by the system or its means.

In one embodiment, the system comprises the robot. In one embodiment, the warning range is or is predefined in such a manner that there is or likely is a collision between the robot and the environment, and/or the all-clear range is or is predefined in such a manner that a collision between the robot and the environment becomes impossible or unlikely.

In one embodiment, the method comprises the step of:
traveling on the checked path with the robot.

As a result, the path can be advantageously checked with the real robot in one embodiment, wherein traveling after checking in the augmented reality advantageously increases safety when traveling with the robot.

Accordingly, one embodiment comprises the system or its means:
means of traveling on the checked path with the robot.

In one embodiment, the method also comprises operating the robot by traveling on the checked path with the robot, and can therefore in particular be a method for operating a robot or the robot. Accordingly, in one embodiment, the system can also be a system for operating a robot or the robot.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 schematically depicts a system for checking a predefined path of a robot according to one embodiment of the present invention; and

FIG. 2 illustrates a method for checking the predefined path of the robot according to one embodiment of the present invention.

### DETAILED DESCRIPTION

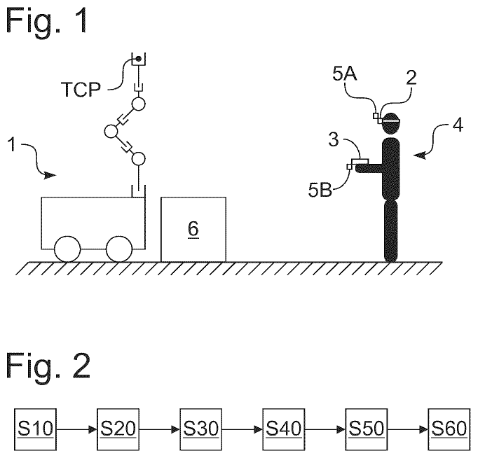

FIG. 1 shows a system for checking a predefined path of a robot 1 using a visualization device in the form of AR glasses 2 or a tablet 3 by a checking person 4.

In a step S10 (see FIG. 2), a real environment 6 of the robot is detected using a detection device 5A or 5B, preferably integrated or detachable, arranged on the visualization device 2 or 3, for example a 3D camera system, lidar sensor or similar, and a computer-implemented environment model is determined in a step S20 with the aid of this data. In a modification (not shown), the environment model can additionally or alternatively be created on the basis of nominal data of the environment or only provided, for example retrieved from a storage.

In a step S30, a distance between a computer-implemented model of the robot and the environment model is determined for different portions, in one embodiment points of the path, wherein the path was predefined, for example, using a simulated environment or by teaching.

For example, the robot model may comprise geometry primitives in the form of cuboids, cylinders or similar, each of which is assigned to one of the moving links of the robot and whose pose or position and orientation changes accordingly in accordance with the relevant portion or path point or during the simulated traveling on the path by the robot. The environment model can comprise, for example, a grid or an approximation surface that approximates a point cloud detected when detecting the real environment. The minimum distance between all these geometry primitives and the grid or approximation surface is then determined as the distance between the robot model and the environment model, for example.

In a step S40, a virtual representation of the path is visualized using the visualization device 2 or 3 in an augmented reality for checking the path, for example the path of the TCP as a line and/or the geometry primitives during simulated travel along the path.

In this visualization, a warning is issued for a portion of the path if the distance determined for this portion falls within a predefined warning range, and an all-clear is issued for a portion of the path if the distance determined for this portion falls within a predefined all-clear range, for example in the manner described above by means of highlighting corresponding portions or similar.

Using this visualized virtual representation and the warnings or all-clear notifications issued for it, the checking person 4 can check in step S40 whether there is a risk of the robot 1 colliding with the environment when traveling on the predefined path and, if so, how great such a risk is.

In doing so, it can advantageously limit itself to or concentrate on the portions for which a warning is issued and check these more precisely and, if necessary, modify the path in a step S50, in particular in such portions, whereupon steps S30, S40 and, if necessary, S50 can be carried out again.

The checked path can be traveled in one step S60 with the real robot.

Although exemplary embodiments have been explained in the preceding description, it is pointed out that a large number of modifications is possible. It is also pointed out that the exemplary embodiments are merely examples that are not intended to restrict the scope of protection, the applications, and the structure in any way. Rather, the preceding description provides a person skilled in the art with guidelines for implementing at least one exemplary embodiment, with various changes, in particular with regard to the function and arrangement of the described components, being able to be made without departing from the scope of protection as it arises from the claims and from these equivalent combinations of features.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SIGNS

1 Robot
2 AR glasses
3 Tablet
4 Checking person
5A; 5B Detection device
6 Environment
TCP Tool center point

What is claimed is:

1-15. (canceled)

16. A method for validating a predefined path of a robot, comprising:
obtaining a computer-implemented, three-dimensional environment model;
determining a distance between a computer-implemented model of the robot and the environment model for different portions of the path;
visually displaying a virtual representation of the path in an augmented reality for checking the path using a visualization device;
issuing a warning in the visual display for a portion of the path in response to a determination that the distance determined for the portion of the path falls within a predefined warning range;
issuing an all-clear message in the visual display for a portion of the path in response to a determination that the distance determined for the portion falls within a predetermined all-clear range.

17. The method of claim 16, further comprising:
detecting data of a real environment of the robot using a detection device;
wherein obtaining the environment model comprises determining the environment model based the detected data.

18. The method of claim 17, wherein at least one of:
the detection device is a mobile detection device;
the detection device is a portable detection device;
the environment model is determined based on the detected data using at least one approximation of features detected with the aid of the detection device; or
the environment model is determined based on the detected data using at least one approximation of points detected with the aid of the detection device.

19. The method of claim 17, wherein at least one of:
the detection device is arranged on the visualization device;
the detection device is moved at least one of translationally or rotationally relative to the real environment in order to detect the data; or
the detection device comprises at least one of:
at least one non-contact measuring distance meter,
at least one camera, or
at least one image evaluation device.

20. The method of claim 16, wherein at least one of:
the environment model is determined on the basis of predefined nominal data, in particular CAD data, of the environment;
the environment model comprises at least one three-dimensional geometry primitive in a predefined relation to a real environmental obstacle;
a model of the robot is determined on the basis of predefined nominal data, in particular the predetermined path of the robot and/or CAD data of the robot;
a measurement of the robot is determined and/or comprises at least one three-dimensional geometry primitive in a predetermined relation to a link of the robot; or
the model of the robot comprises a computer-implemented model of a robot-guided tool or workpiece as a moving link of the robot.

21. The method of claim 16, wherein the environment model is determined on the basis of at least one of:
the robot;
a model of the robot; or
a selection of an environment area by a checking person.

22. The method of claim 21, wherein determining the environment model on the basis of the robot comprises determining based on data of the robot detected using a detection device.

23. The method of claim 16, wherein determining the distance between the model of the robot and the environment model for at least one of the portions of the path comprises determining the distance based on a minimum distance between an imaginary envelope of at least one movable link of the robot with an imaginary envelope of the entire environment of the robot described by the environment model, or an imaginary envelope of a selected partial region of the environment of the robot.

24. The method of claim 23, wherein:
the imaginary envelope of the at least one movable link of the robot comprises an imaginary envelope of a plurality of movable links of the robot; or
the imaginary envelope of the at least one movable link of the robot is an imaginary envelope of all movable links of the robot.

25. The method of claim 16, wherein the virtual representation of the path comprises at least one of:
a path of a robot-fixed reference point as it moves along the path; or
a representation of at least one movable link of the robot as it moves along the path.

26. The method of claim 25, wherein at least one of:
the path of the robot-fixed reference point comprises a continuous path of the robot-fixed reference point;
the robot-fixed reference point is and end effector of the robot;
the representation of at least one movable link comprises a representation of a plurality of the movable links of the robot; or
the representation of at least one movable link comprises a simulation of the robot travelling on the path.

27. The method of claim 16, wherein visually displaying the virtual representation of the path comprises:
visually displaying a portion of the path in a first virtual representation in response to the distance determined for that portion of the path falling within the warning range; and
visually displaying the portion of the path in a second virtual representation, different from first virtual representation, in response to the distance determined for the portion of the path falling within the all-clear range.

28. The method of claim 27, further comprising at least one of:
visually displaying the portion of the path in a third virtual representation in response to the distance determined for that portion of the path falling within a specified part of the warning range; and
visually displaying the portion of the path in a fourth virtual representation in response to the distance determined for the portion of the path falling within a specified part of the all-clear range.

29. The method of claim 16, further comprising at least one of:
indicating at least one path parameter during the visual displaying of the virtual representation of the path; or
indicating a value of the determined distance for at least one portion of the path during the visual displaying of the virtual representation of the path.

30. The method of claim 29, wherein at least one of:
the at least one portion of the path is a point on the path;
the at least one portion of the path is a portion of the path travelled on or approached in a simulated manner during the visual displaying;
the at least one path parameter is a velocity;
the value of the determined distance is at least one of a global minimum distance or a distance for the at least one selected portion of the path; or
indicating the path parameter or the value of the determined distance comprises indicating at least one of numerically, acoustically, or symbolically.

31. The method of claim 16, further comprising at least one of:
confirming validation of the path, performed by a user, using the visualized virtual representation and the issued warning or all-clear message;
modifying the path; or
travelling on the validated path with the robot.

32. The method of claim 31, wherein at least one of:
confirming validation of the path comprises validating at least a portion of the virtual representation for which a warning is issued; or
modifying the path comprises modifying the portion of the path for which a warning is issued.

33. The method of claim 31, further comprising:
visually displaying a virtual representation of the modified path using the visualization device in the augmented reality for checking the modified path;
issuing a warning in the visual display for a portion of the modified path in response to a determination that the distance determined for the portion of the modified path is within a predefined warning range; and
issuing an all-clear message in the visual display for a portion of the modified path in response to a determination that the distance determined for the portion of the modified path is within a predefined all-clear range.

34. A system for validating a predefined path of a robot, the system comprising:
means for providing a computer-implemented three-dimensional environment model;
means for determining a distance between a computer-implemented model of the robot and the environment model for different portions of the path; and
a visualization device configured for visually displaying a virtual representation of the path in an augmented reality for checking the path;
wherein a warning is issued in the visual display for a portion of the path in response to a determination that the distance determined for the portion of the path falls within a predefined warning range; and
wherein an all-clear message is issued in the visual display for a portion of the path in response to a determination that the distance determined for the portion falls within a predetermined all-clear range.

35. A computer program comprising program code stored on a non-transitory, computer-readable storage medium, the program code, when executed by one or more computers, causing the one or more computers to carry out the method of claim 16.
